(19) United States
(12) Patent Application Publication
(10) Pub. No.: US 2018/0179035 A1
(43) Pub. Date: Jun. 28, 2018

(54) Lifting System for Lifting a Vehicle with Indirect Height Measurement and Method Therefor

(71) Applicant: Stertil B.V., Kootstertille (NL)

(72) Inventor: Jurjen Jan De Jong, Buitenpost (NL)

(21) Appl. No.: 15/738,748

(22) PCT Filed: Jul. 6, 2016
(86) PCT No.: PCT/NL2016/050481

§ 371 Date: Dec. 21, 2017

Related U.S. Application Data
(63) Continuation of application No. 14/791,644, filed on Jul. 6, 2015.

(51) Int. Cl. B66F 3/24; B66F 7/06; B66F 3/46

(52) U.S. Cl. CPC B66F 3/24; B66F 7/0691; B66F 7/0666; B66F 3/46

(57) ABSTRACT

A lifting system for lifting a vehicle, including a mobile frame with a moveable carrier configured for carrying the vehicle; a drive which acts on the carrier and has a hydraulic system; a measurement system including a sensor configured for indirect measurement of the height of the carrier, with the sensor configured for generating an indirect measurement signal from the hydraulic system that is indicative for the height of the carrier, or a change thereof; and a controller configured for controlling the height of the carrier in response to the indirect measurement signal of the measurement system.

The invention relates to a lifting system for lifting a vehicle such as passenger cars, trucks, busses and other vehicles, and more specifically a mobile lifting column such as a wireless mobile lifting column.

Lifting columns are known from practice and comprise a frame with a carrier that is connected to a drive for moving the carrier upwards and downwards. In the ascent mode, hydraulic oil is pumped to a cylinder for lifting the carrier and, therefore, the vehicle. In the descent mode, the carrier with the vehicle is lowered and hydraulic oil returns to the reservoir. Such prior art lifting system is disclosed in U.S. Patent Application Publication No. 2006/0182563, which is incorporated herein by reference.

Measurement of the height of the carrier of a lifting system can be disturbed by noise signals, interfering signals, sensor fouling etc. This may lead to an unreliable or insufficiently accurate height measurement.

An object of the present invention is to obviate or at least reduce the aforementioned problems associated with the height measurement for a lifting system.

This object is achieved with the lifting system for lifting a vehicle, such as a passenger car, truck, bus or other vehicle, with the lifting system comprising:
a mobile frame with a moveable carrier configured for carrying the vehicle;
a drive which acts on the carrier and comprises a hydraulic system;
a measurement system comprising a sensor configured for indirect measurement of the height of the carrier, with the sensor configured for generating an indirect measurement signal from the hydraulic system that is indicative for the height of the carrier, or a change thereof; and
a controller configured for controlling the height of the carrier in response to the indirect measurement signal of the measurement system.

The carrier of the lifting device is capable of carrying the vehicle that needs to be lifted. The carrier moves upward and/or downward relative to the frame of the lifting column with a drive. In a presently preferred embodiment, the drive comprises a hydraulic cylinder drive unit that is configured for raising the carrier. This unit comprises a housing, a piston rod that is movable in the housing of the cylinder and a hydraulic system. In one of the embodiments according to the invention the unit is embodied as an integrated hydraulic cylinder drive unit as disclosed in U.S. Patent Application Publication No. 2016/0052757 which is incorporated herein by reference.

The lifting system comprises a height measuring system that is configured for indirectly measuring the height and/or displacement of the carrier through the use of a measurement of the hydraulic system. The use of this height measuring system provides information about the height of the carrier. This measuring system provides an indirect measurement enabling feedback on the actual displacement of the carrier. This obviates the need for separate sensor systems on the carrier or frame, such as a potentiometer, thereby reducing the complexity of the lifting device, and reducing the risk of additional noise or disturbances influencing measurement signals and/or communication between the different components of the lifting device. This improves the accuracy and/or robustness of the measurement system.

Furthermore, as the height measurement is based on (a change) in the hydraulic system any measurement of a displacement is directly available such that there is no time delay and, if necessary, appropriate control actions can be taken directly. This improves the safety of the lifting device according to the present invention.

As a further advantage, the indirect measurement in the hydraulic system provides an explosion proof measurement system. This further improves the overall safety of lifting systems for lifting a vehicle.

In addition, by providing an indirect measurement based on the hydraulic system, preferably measuring changes in the hydraulic system, enables a detection of any leakage of hydraulic fluid from the system. This improves the environmental performance of the lifting system. Furthermore, the measurement can be compared with the theoretical changes of the hydraulic system by comparing with the motor RPM thereby further enabling a detection of any leakage. Furthermore, such comparison may provide an indication of wear of components of the system. This may provide an accurate indication of required preventive maintenance.

In an embodiment of the present invention, the measurement system comprises a sensor that is contained in the hydraulic system, for example in the hydraulic reservoir and/or in the hydraulic connections, such as pipes or tubes. This provides a stable environment for the sensor or sensor components. This reduces the risk of fouling or temperature fluctuations that may influence the measurements. Therefore, this contributes to the accuracy and robustness of the measurement system in such embodiment.

Lifting devices according to the invention include (wireless) mobile lifting columns. As an example, a number of lifting columns can be grouped together as a lifting system. In an embodiment of such a lifting system according to the invention, when lifting a vehicle, at least two lifting columns are being used. In fact, often four lifting columns are being used. During such lifting operation, the timing of these separate lifting columns, preferably including the moving speed of the carrier that carries (part of) the vehicle when lifting a vehicle, requires synchronization. The control of the lifting system preferably comprises a system controller that synchronizes the height of the separate carriers in the ascent mode using, for example, a measurement signal generated by the measurement system of the present invention.

In case one of the carriers has moved too fast in the ascent mode and is too high as compared to the other carriers of the other lifting columns, for example the power supply to this carrier is either directly or indirectly lowered so that the other carriers can catch up. Alternatively or in addition thereto, the power supply to the other carriers is either directly or indirectly increased so that the other carriers can catch up. In the descent mode, it is also important that the height of the carriers between the several lifting columns is synchronized. Therefore, in case one of these carriers has moved too slowly, for example its power supply is increased in order for this carrier to catch up with the other carriers. Alternatively or in addition thereto, the power supply to the other carriers is either directly or indirectly lowered so that the other carriers can catch up.

In one of the preferred embodiment of the invention the drive acting on a carrier comprises a hydraulic liquid reservoir, and the sensor of the measurement system is configured for measuring the level, pressure, or volume of the hydraulic liquid and/or the change thereof.

By measuring the level or volume of the hydraulic liquid in the reservoir, or a change thereof, the measurement signal is indicative for the amount of hydraulic liquid that is provided towards the drive, such as a cylinder, that moves the carrier is achieved. This provides measurement information about the height of the carrier or change thereof, even before actual displacement of the carrier takes place. This achieves the aforementioned effects and advantages. It will be understood that the level indication of the hydraulic liquid in the reservoir relates to the amount of hydraulic liquid that is provided to and/or received from the drive. It will be understood that any shape of the reservoir can be compensated for.

The sensor preferably comprises one or more of the following sensors: an ultrasonic hydraulic liquid level sensor, a float sensor configured for measuring the hydraulic liquid level, a pressure sensor configured for measuring pressure and/or pressure differences in the reservoir.

An ultrasonic sensor can be provided above the hydraulic liquid level and measure a distance from the reference point of the sensor to this surface level. Any change of this distance indicates a change of the height of the carrier of the lifting system. In a similar way, a float sensor can be implemented as an alternative or in addition to the ultrasonic sensor. Such float sensor may comprise an electromagnetic float and/or resistance element and/or an inclinometer. This provides a direct measurement of any change of the level of the hydraulic liquid surface.

A pressure sensor can be applied to measure and pressure differences in response to a change in the volume of the hydraulic liquid in the reservoir. This may involve providing a pressure sensor in the room or chamber above the hydraulic liquid surface and/or providing a pressure sensor in a separate measurement tube that is connected to the hydraulic reservoir and/or a weight measurement of the hydraulic liquid that is contained in the reservoir.

In addition to the aforementioned sensor types, or as an alternative thereto, a flow sensor can be provided in the hydraulic liquid pipe or tube between the reservoir and the drive. The drive may relate to components such as the hydraulic pump of the drive and/or hydraulic cylinder of the drive. Such flow sensor provides an accurate measurement of the amount of hydraulic liquid that is transferred between the reservoir and the drive unit.

In some of the embodiments of the invention one or more additional sensors can be provided to improve the accuracy of the measurement. For example, a temperature sensor can be provided at or close to the location of the sensor of the measurement system to enable temperature correction of the measurement signal. This further improves the overall accuracy of the measurement information.

In a further preferred embodiment according to the invention the drive comprises a reservoir with a submerged pump. By providing a submerged pump a compact and effective hydraulic circuit is achieved with a significant reduction of the number of hoses and connections. This further reduces the risk of hydraulic fluid, such as hydraulic oil, leaking from the lifting system. In addition, the amount of hydraulic liquid that is required for a lifting system is further reduced.

The present invention also relates to a method for controlling a lifting system for lifting a vehicle, the method comprising the steps of:
providing a lifting system comprising:
   a mobile frame with a moveable carrier configured for carrying the vehicle;
   a drive which acts on the carrier and comprises a hydraulic system;
   a measurement system comprising a sensor configured for indirect measurement of the height of the carrier, with the sensor configured for generating an indirect measurement signal from the hydraulic system that is indicative for the height of the carrier, or a change thereof; and
   a controller configured for controlling the height of the carrier in response to the indirect measurement signal of the measurement system;
lifting the vehicle with the drive acting on the carrier;
indirectly measuring the height of the carrier and providing the controller with the indirect measurement signal from the hydraulic system; and
in response to the indirect measurement signal received by the controller determining the presence of height differences and providing one or more control signals to correct a determined height differences of the carrier.

The method provides the same effects and advantages as those stated for the lifting system. The lifting system may comprise a number of mobile lifting columns acting as lifting system, for example. The individual lifting devices or lifting columns can be controlled by a central controller of the lifting system, for example. This further improves the accuracy and safety of the lifting system.

In an embodiment of the invention the method comprises indirectly measuring the hydraulic liquid level, pressure, or volume and/or a change thereof. This provides an effective control of the lifting operation. In addition thereto or as an alternative thereto, the flow between the drive of the carrier and the hydraulic liquid reservoir can be measured.

The invention further also relates to a lifting system for lifting a vehicle, the system comprising:
a mobile frame with a moveable carrier configured for carrying the vehicle;
a drive which acts on the carrier and comprises a hydraulic system;
a measurement system comprising a sensor configured for indirect measurement of the height of the carrier, with the sensor configured for generating an indirect measurement signal indicative for a height of the carrier or change thereof,
wherein the sensor of the measurement system is configured to measure a force generated by a spring element with one end connected to the carrier and with another end connected to a reference point.

Such lifting system provides the same effects and advantages as those stated for the aforementioned lifting system and/or method. By measuring the displacement of the spring element and/or the spring force of any such displacement an indirect measurement of the carrier height can be achieved.

The invention further also relates to a lifting system for lifting a vehicle, the system comprising:
a mobile frame with a moveable carrier configured for carrying the vehicle;
a drive which acts on the carrier and comprises a hydraulic system;
a measurement system comprising a sensor configured for indirect measurement of the height of the carrier, with the sensor configured for generating an indirect measurement signal indicative for a height of the carrier or change thereof,
wherein the sensor of the measurement system is configured for measuring an angle between the carrier and the frame and/or the change thereof.

Such lifting system provides the same effects and advantages as those stated for the aforementioned lifting systems and/or method. The sensor for measuring an angle between the carrier and the frame preferably comprises a sensor component that is attached to the carrier and a sensor component that is attached to the foot of the lifting system. By changing the height of the carrier the angle of the measurement signal changes relative to the substantially vertical direction of the mast. This provides information about the actual height of the carrier

Exemplary embodiments of a lifting system and/or the method according to the present invention are described here below on the basis of a non-limitative exemplary embodiment therefor shown in the accompanying drawings, wherein:

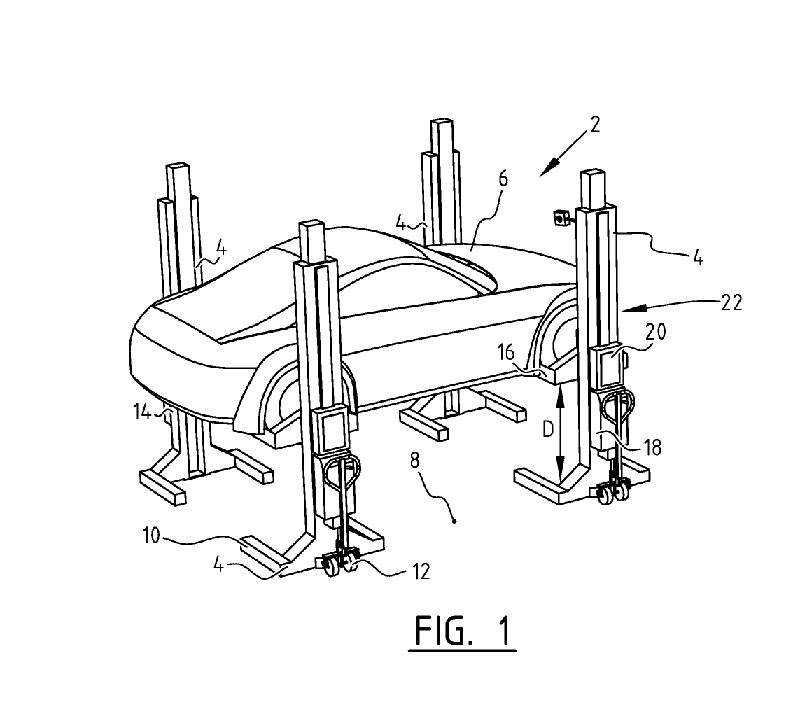

FIG. 1 shows a schematic overview of a vehicle lifted by lifting columns for a lifting system according to the invention;

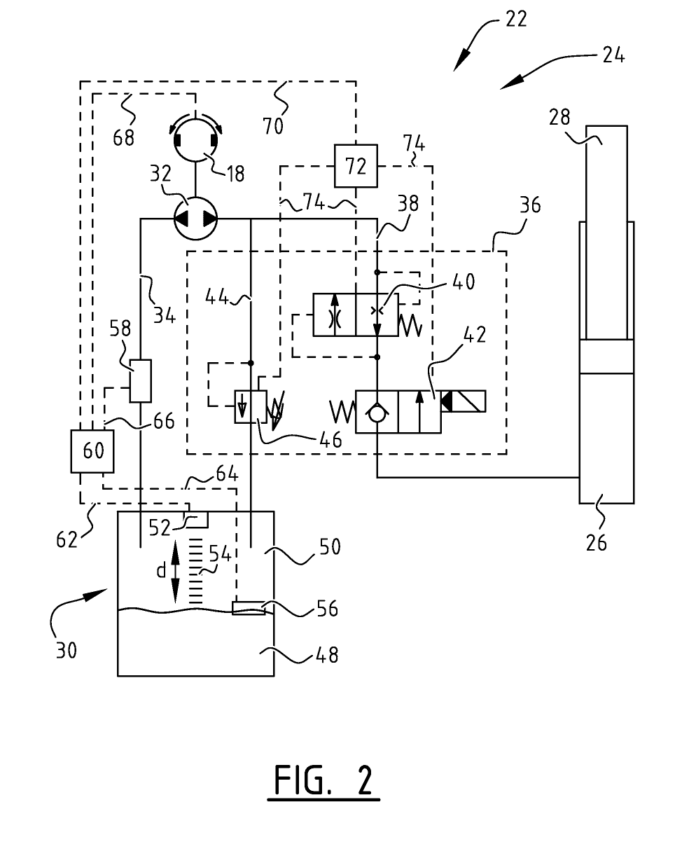

FIG. 2 shows a schematic overview of the hydraulic scheme of the drive of FIG. 1 including components of the measurement system; and

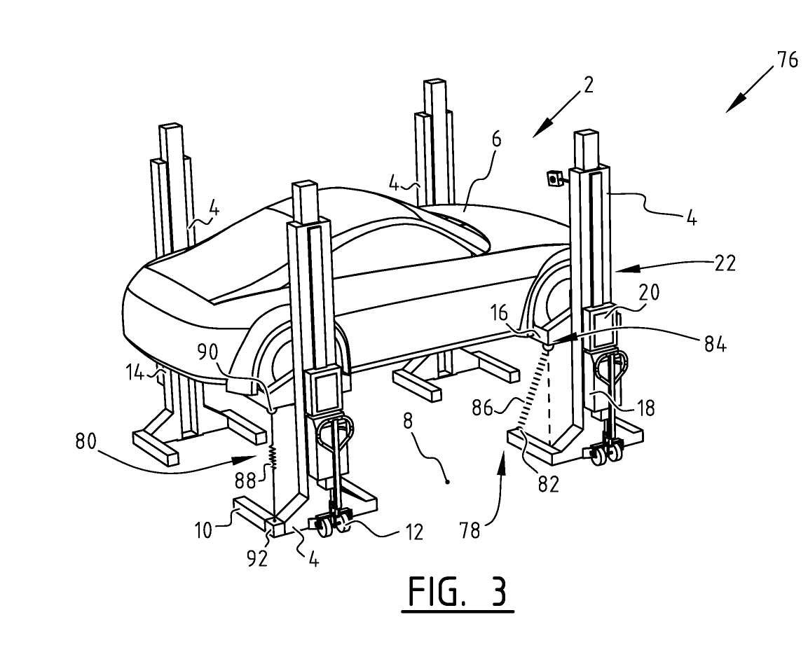

FIG. 3 shows alternative measurement systems.

System 2 for efficient lifting and lowering load 6 (FIG. 1) comprises four wireless mobile lifting columns 4. Lifting columns 4 lift passenger car 6 from ground 8. In the illustrated embodiment lifting columns 4 are connected to each other and/or a control system by wireless communication means or alternatively by cables. Lifting columns 4 comprise foot 10 which can travel on running wheels 12 over ground surface 8 of for instance a floor of a garage or workshop. In the forks of foot 10 is provided an additional running wheel (not shown). Lifting column 4 furthermore comprises mast 14. Carrier 16 is moveable upward and downward along mast 14. Carrier 16 is driven by motor 18 of the drive of the lifting column that is provided in a housing of lifting column 4. Motor 18 is supplied with power from the electrical grid or by a battery that is provided on lifting column 4 in the same housing as motor 18, or alternatively on foot 10 (not shown). Control with control panel 20 is provided to allow the user of system 2 to control the system, for example by setting the speed for carrier 16. In one embodiment, motor 18 is a 3-phase low voltage motor controlled by a separate controller. In another embodiment, motor 18 is a 3-phase low voltage motor with integrated controller. Such motor with integrated controller can also be used in combination with conventional lifting devices with conventional height measurement systems.

Each of the lifting columns has at least one ascent mode and one descent mode, and is under the influence of control 20. Control 20 can be designed for each lifting column 4 individually, or for the lifting columns 4 together. A pressure or load sensor may be used for monitoring, control and indication of the load that is lifted with lifting system 2.

Measurement system 22 provides an indirect measurement of the carrier height D. In the illustrated embodiment measurement system 22 is included in hydraulic circuit 24 (FIG. 2). In the illustrated embodiment hydraulic circuit 24 is operatively connected to hydraulic cylinder 26 with piston 28 that drives carrier 16. Motor 18 provides cylinder 26 with hydraulic liquid, such as oil, from reservoir 30 by activating pump 32. Pump 32 is connected to reservoir 30 with suction pipe 34. Valve block 36 directs hydraulic liquid from reservoir pump 32 towards supply pipe 38 through valve 40. Liquid is directed through valve 42 towards hydraulic cylinder 26. Recirculation pipe 44 with valve 46 enables recirculation of hydraulic liquid in a reservoir 30.

It will be understood that alternative embodiments of hydraulic circuit 24 can be envisaged in accordance with the present invention.

In the illustrated embodiment hydraulic liquid 48 is contained in reservoir 30. Above hydraulic liquid 48 there is provided room or chamber 50.

In one of the embodiments of the invention ultrasonic sensor 52 is provided in room 50 capable of measuring distance d between sensor 52 and hydraulic liquid 48 with ultrasonic signal 54. Alternatively, or in addition thereto, float 56 can be used to measure the hydraulic liquid level directly. Furthermore, in addition or as an alternative to the aforementioned sensor(s), flow sensor 58 can be provided in hydraulic circuit 24, for example in suction pipe 34. It will be understood that other locations for flow sensor 58 can also be envisaged in accordance with the present invention.

Controller 60 receives measurement signals 62, 64, 66 from sensors 52, 56, 58. Controller 60 determines the height of carrier 16. Preferably, controller 60 is a central controller configured for controlling the lifting columns, optionally communicating with (local) controllers of lifting devices. Controller 60 and/or the local controllers determine the height and/or speed differences between individual carriers 16 and determine required control actions. These control actions may result in sending control signal 68 to motor 18 and/or other control signals 70.

In the illustrated embodiment control signal 70 is provided to valve controller 72 that directs appropriate control signals 74 to individual valves 40, 42, 46 of valve block 36. It will be understood that other configurations for the controller can be envisaged in accordance to the present invention.

Alternative measurement system 76 can be applied in combination with or as an alternative to measurement system 22 that is illustrated in FIG. 1. Measurement system 76 (FIG. 3) comprises a first sub-system 78 and a second sub-system 80 that can be used in combination, as an alternative, and/or in combination with measurement system 22, or as an alternative therefor. Measurement system 78 comprises a transceiver 82. In the illustrated embodiment transceiver 82 is attached to foot 10. A second transceiver 84 is attached to carrier 16. When moving carrier 16, signal 86 changes its direction between transceivers 82, 84, or more specifically changes its angle relative to the vertical as determined by mast 14. This angle α provides a measurement for the actual height of carrier 16.

Measurement system 80 comprises height element 88 that is connected at connection 90 to carrier 16 and with measuring unit 92 to foot 10. The force measured by sensor 92 is a measurement for the height of carrier 16. In the illustrated embodiment element 88 is a spring element.

The present invention can be applied to the (wireless) lifting columns illustrated in FIG. 1. Alternatively the invention can also be applied to other types of lifting columns and lifting systems.

The present invention is by no means limited to the above described preferred embodiments. The rights sought are defined by the following claims within the scope of which many modifications can be envisaged. It will be understood that instead of the ultrasonic sensor other types of sensors can be applied similarly in accordance with the present invention. This may involve optical sensors, or sensors making use of other signal types operating in a similar manner as described in relation to the ultrasonic sensor 20.

1.-14. (canceled)

15. A lifting system for lifting a vehicle, the system comprising:
a mobile frame with a moveable carrier configured for carrying the vehicle;
a drive which acts on the carrier and comprises a hydraulic system;
a measurement system comprising a sensor configured for indirect measurement of the height of the carrier, with the sensor configured for generating an indirect measurement signal from the hydraulic system that is indicative for the height of the carrier, or a change thereof; and
a controller configured for controlling the height of the carrier in response to the indirect measurement signal of the measurement system.

16. The lifting system according to claim 15, wherein the drive acting on the carrier comprises a hydraulic liquid reservoir and hydraulic connections, and wherein the sensor of the measurement system is contained in the hydraulic reservoir and/or in the hydraulic connections and is configured for measuring the level, pressure, or volume of hydraulic liquid and/or the change thereof.

17. The lifting system according to claim 16, wherein the sensor of the measurement system comprises one or more of the following sensors: an ultrasonic hydraulic liquid level sensor, a float sensor configured for measuring the hydraulic liquid level, a pressure sensor configured for measuring pressure and/or pressure differences in the reservoir, and a weight measurement of the hydraulic liquid that is contained in the reservoir.

18. The lifting system according to claim 17, wherein the float sensor comprises an electromagnetic float and/or resistance element and/or an inclinometer.

19. The lifting system according to claim 15, wherein the sensor of the measurement system comprises a flow sensor configured for measuring the flow of hydraulic liquid to and/or from the drive.

20. The lifting system according to claim 15, wherein the measurement system further comprises a temperature sensor enabling a temperature compensation of the indirect measurement.

21. The lifting system according to claim 16, wherein the drive comprises a pump that is submerged in the reservoir.

22. The lifting system according to claim 15, wherein the lifting system comprises a group of lifting columns.

23. The lifting system according to claim 16, wherein the lifting system comprises a group of lifting columns.

24. The lifting system according to claim 21, wherein the lifting system comprises a group of lifting columns.

25. A method for controlling a lifting system for lifting a vehicle, the method comprising:
providing a lifting system comprising:
a mobile frame with a moveable carrier configured for carrying the vehicle;
a drive which acts on the carrier and comprises a hydraulic system;
a measurement system comprising a sensor configured for indirect measurement of the height of the carrier, with the sensor configured for generating an indirect measurement signal from the hydraulic system that is indicative for the height of the carrier or the change thereof; and
a controller configured for controlling the height of the carrier in response to the indirect measurement signal of the measurement system;
lifting the vehicle with the drive acting on the carrier;
indirectly measuring the height of the carrier and providing the controller with the indirect measurement signal from the hydraulic system; and
in response to the indirect measurement signal received by the controller determining the presence of height differences and providing one or more control signals to correct a determined height difference of the carrier.

26. The method according to claim 25, wherein indirectly measuring comprises measuring a hydraulic liquid level or volume and/or a change thereof.

27. The method according to claim 25, wherein indirectly measuring comprises measuring a hydraulic pressure and/or a change thereof.

28. The method according to claim 25, wherein indirectly measuring comprises measuring a hydraulic liquid flow to and/or from the drive.

29. The method of claim 25, further comprising comparing the measurement with theoretical changes of the hydraulic system to enable detection of leakage and/or wear of components.

30. The method of claim 29, comprising comparing the step of comparing with a motor RPM.

31. The method of claim 25, further comprising synchronizing lifting columns of the lifting system during a lifting operation, the synchronizing including moving speed of the carrier.

32. The method of claim 31, wherein the lifting system comprises two or more lifting columns.

33. A lifting system for lifting a vehicle, the system comprises:
a mobile frame with a moveable carrier configured for carrying the vehicle;
a drive which acts on the carrier and comprises a hydraulic system;
a measurement system comprising a sensor configured for indirect measurement of the height of the carrier, with the sensor configured for generating an indirect measurement signal indicative for a height of the carrier or change thereof,
wherein the sensor of the measurement system is configured to measure a force generated by a spring element with one end connected to the carrier and with another end connected to a reference point.

34. A lifting system for lifting a vehicle, the system comprising:
a mobile frame with a moveable carrier configured for carrying the vehicle;
a drive which acts on the carrier and comprises a hydraulic system;
a measurement system comprising a sensor configured for indirect measurement of the height of the carrier, with the sensor configured for generating an indirect measurement signal indicative for a height of the carrier or change thereof,
wherein the sensor of the measurement system is configured for measuring an angle between the carrier and the frame and/or the change thereof.
